(19) United States
(12) Patent Application Publication
(10) Pub. No.: US 2002/0041378 A1
(43) Pub. Date: Apr. 11, 2002

(54) Polarized light fluorescence imageing device

(75) Inventors: Philippe Peltie, St. Paul-de-Varces (FR); Raymond Campagnolo, Grenoble (FR); Michel Berger, Claix (FR)

Correspondence Address: BURNS DOANE SWECKER & MATHIS L L P, POST OFFICE BOX 1404, ALEXANDRIA, VA, 22313-1404, US

(73) Assignee: International Business Machines Corporation, Armonk, NY

(21) Appl. No.: 09/915,514

(22) Filed: Jul. 27, 2001

(30) Foreign Application Priority Data
Aug. 8, 2000 (FR) 00 10426

(51) Int. Cl. G01N 21/64

(52) U.S. Cl. 356/417

(57) ABSTRACT

The invention relates to a polarized light fluorescence imaging device comprising a structure of parallel microchannels (4) for containing the constituents to be analyzed. A coupling device (2,5) enables polarized light to be guided into the microchannels.

The invention is applied to the analysis of labelled nucleic acid sequences.

### TECHNICAL FIELD AND PRIOR ART

This invention relates to a polarized light fluorescence imaging device.

Polarized fluorescence is used for detecting the motion of molecules and consequently the size of molecules. Actually, the polarization of the fluorescence light re-emitted by a molecule is all the less changed with respect to the polarization of the excitation light received by the molecule that the molecule is of a large size.

Polarized fluorescence has been used for a long time for detecting partial motions of a polymer by labelling it with a fluorescent emissive substance.

Present applications mainly relate to interactions between proteins (study of antigen-antibody reactions in immunology, biochemical reactions such as enzymes-substrates reactions) and the study of membranes.

Polarized fluorescence, as well as energy transfer are also used for separating molecules (e.g. cytometry).

More recently, polarized fluorescence was used for analysis of labelled nucleic acid sequences. So, let us cite the article, “Fluorescence Polarization in Homogenous Nuclei Acid Analysis” by Chen, Levine and Kwok, Genome Research, September 1998, and the article, “A homogeneous method for genotyping with fluorescence polarization”, by Neil J. Gibson, Helen L. Gillard, David Whitcombe, Richard M. Ferrie, Clive R. Newton and Stephen Little, Clinical Chemistry 43:8, 1336-1341.

As regards applications relating to interactions between proteins, two articles may be cited:

“Fluorescence Anisotropy: Rapid, Quantitative Assay for Protein-DANA and Protein-Protein Interaction” by Tomasz Heyduk, Yuexing Ma, Hong Tang and Richard H. Ebright, Methods in Enzymology, Vol. 274, and

“DNA detection by strand displacement amplification and fluorescence polarization with signal enhancement using a DNA binding protein” by G. Terrance Walker, G. Preston Linn and James G. Nadeau, Nucleic Acids Research, 1996, Vol 24, NO 2.

Two European Patents may also be cited relating to the polarized fluorescence method:

European Patent EP 0 382 433 B1 entitled “Detection of nucleic acid sequences using fluorescence polarization”, and

European Patent EP 0 678 581 A1 entitled “Fluorescence polarization detection of nucleic acid amplification”.

A great number of devices for implementing fluorescence polarization measurements are known from the prior art. For instance, spectrophotometers provides with polarization accessories may be mentioned. The investigated spectra are then spectra from monochromators, in front of which are placed polarization filters. White light is vertically polarized before reaching the sample and the sample's fluorescence is alternately analyzed with vertical then horizontal polarization. The degree of polarization is given by the formula below:

$$P = \frac{{I}_{II} - {GI}_{⊥}}{{I}_{II} + {GI}_{⊥}}$$

wherein I_{//} and I_{⊥} are the intensities measured in vertical and horizontal polarizations respectively, and G is a correction factor which accounts for the natural imbalance between vertical and horizontal polarizations due to the fact that monochromators do not give the same values for both polarization axes.

These spectra have the advantage of allowing the whole spectral range to be explored, both in emission and in excitation. However, they lack sensitivity as the monochromators are very selective films which have relatively high attenuation.

There are also readers for well plates. Well plate readers operate either with a filtered white source lamp or with lasers.

Measurement in wells tends to depolarize the light (presence of liquid-air meniscus). As a result, their performances in polarization are limited.

There are also investigation benches with two simultaneous channels. Now, n measurement points may be scanned, but this requires mechanical motion and a synchronization device which make implementation delicate of these benches in an industrial environment.

The fluorescence imaging device according to the invention does not have the aforementioned drawbacks.

### DESCRIPTION OF THE INVENTION

Indeed, the invention relates to a fluorescence imaging device comprising first means for containing the constituents to be analyzed, second means for illuminating the constituents to be analyzed with polarized light and third means for measuring fluorescence light emitted by the constituents under the action of polarized light. The first means consists of a structure of parallel microchannels and the second means comprise at least one coupling device for guiding polarized light into the microchannels.

The device according to the invention provides easy discrimination of molecules with different sizes. It is thereby possible, for example to discriminate a sequence of 16 to 20 nucleic acids labelled with a fluorophore in a solution containing non-labelled oligonucleotides and fluorophores in the free state. This may be used in genotyping reactions for study of polymorphism.

According to the preferred embodiment of the invention, polarization of the light illuminating the constituents to be analyzed is a vertical polarization.

### BRIEF DESCRIPTION OF THE FIGURES

Other features and advantages of the invention will become apparent upon reading the description of a preferred embodiment of the invention, with reference to the figures appended herein, wherein:

FIG. 1 illustrates a first example of the polarized light coupling device in a microchannel structure according to the invention;

FIG. 2 illustrates a second example of the polarized light coupling device in a microchannel structure according to the invention;

FIG. 3 illustrates a third example of the polarized light coupling device in a microchannel structure according to the invention;

FIG. 4 illustrates a first example of the polarized fluorescent light readout device according to the invention;

FIG. 5 illustrates a second example of the polarized fluorescent light readout device according to the invention;

FIG. 6 illustrates a third example of the polarized fluorescent light readout device according to the invention;

FIG. 7 symbolically illustrates a fluorescence image according to the invention obtained with a device such as the device of FIG. 6;

FIG. 8 illustrates a fourth example of the polarized fluorescent light readout device according to the invention;

FIG. 9 symbolically illustrates a fluorescence image according to the invention obtained with a device such as the device of FIG. 8;

### DETAILED DESCRIPTION OF THE PREFERRED EMBODIMENTS OF THE INVENTION

With the device according to the invention, it is possible to achieve polarized fluorescence imaging of components distributed in N parallel microchannels, wherein N is an integer, which may be equal to 100, for example. The microchannels may either be etched in a glass or high optical quality plastic or even silicon support chip, or consist of flexible capillaries.

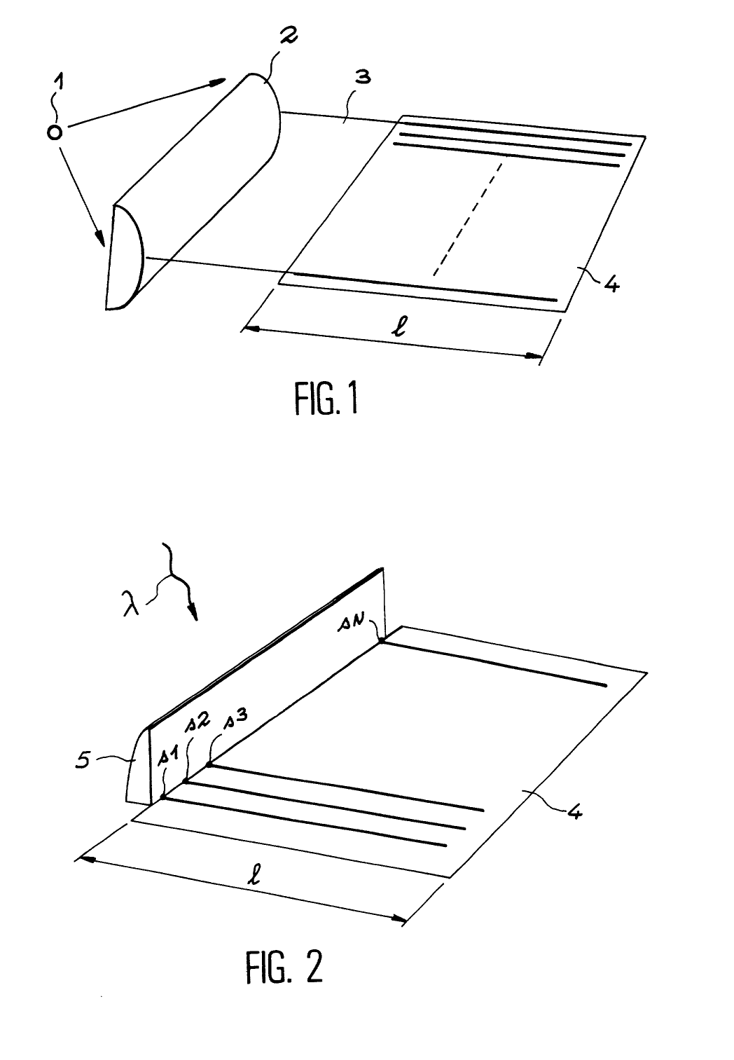

According to the invention, a coupling device enables light to be guided into the N parallel microchannels, and thereby N fluorescent sections are obtained with a length l between 1 mm and 10 mm for example. As a non-limiting example, the microchannels have a section of 200 μm and their pitch is 400 μm. The coupling device may be a cylindrical lens as illustrated in FIG. 1 or diffraction grating as illustrated in FIG. 2.

In FIG. 1, a cylindrical lens 2 illuminated by a laser source 1 may provide a thin plane of laser light 3 which penetrates the structure 4 of microchannels. A “laser source” means both a laser and a microlaser.

In FIG. 2, a diffraction grating 5 illuminated by a light of wavelength λ enables N distinct source points to be generated, s1, s2, s3, . . . , sN. Each point source is aligned with a microchannel. With this last configuration, parasitic diffusion problems and cross-talk problems between the microchannels may advantageously be prevented.

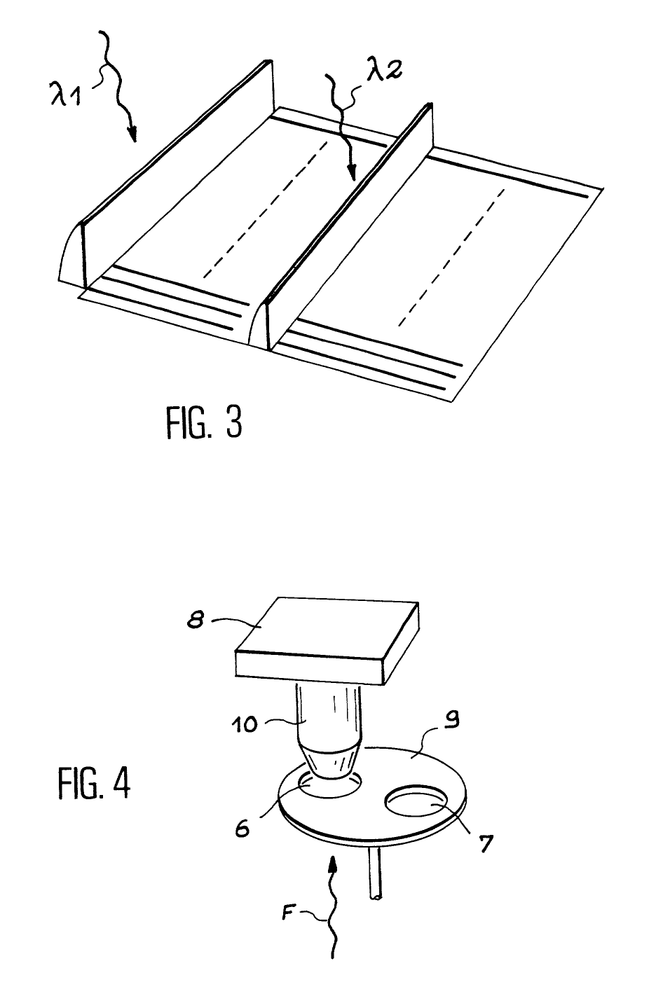

FIG. 3 illustrates a third example of the polarized light coupling device in a microchannel structure according to the invention.

According to this third example, fluorescence of two distinct tracers is imaged. The microchannel structure then consists of two elementary structures, for example, as illustrated in FIG. 2. A light of wavelength λ1 excites the tracers contained in the microchannels of the first elementary structure and a light of wavelength λ2 excites the tracers contained in the microchannels of the second elementary structure.

A structure as illustrated in FIG. 3, is used, for example, in genotyping reactions for studying polymorphism. A first tracer is then selected from the fluoresceins (excitation wavelength λ1 substantially between 488 nm and 514 nm and emission wavelength substantially equal to 520 nm) and the second tracer is selected from rhodamines (excitation wavelength λ2 substantially between 530 nm and 550 nm and emission wavelength substantially equal to 580 nm). As a non-limiting example, the first tracer is FAM (carboxyfluorescein) and the second tracer is TAMRA (tetramethylrhodamine).

FIG. 4 illustrates a first example of the polarized fluorescent light readout device according to the invention.

With optics 10 and polarizing filters 6 and 7, the N parallel microchannels may be imaged on a CCD (Charge Coupled Device) camera. As a non-limiting example, polarizing filters 6 and 7 are mounted on a filter wheel 9. The fluorescence light F from the N microchannels is then detected. The imaging of the N microchannels is performed, first of all according to a first direction of polarization then according to the direction perpendicular to the first direction of polarization. Two channel intensities I_{//} and I_{⊥} are thereby obtained, channel by channel. The resulting polarization is given by:

$$P = \frac{{I}_{II} - {I}_{⊥}}{{I}_{II} + {I}_{⊥}}$$

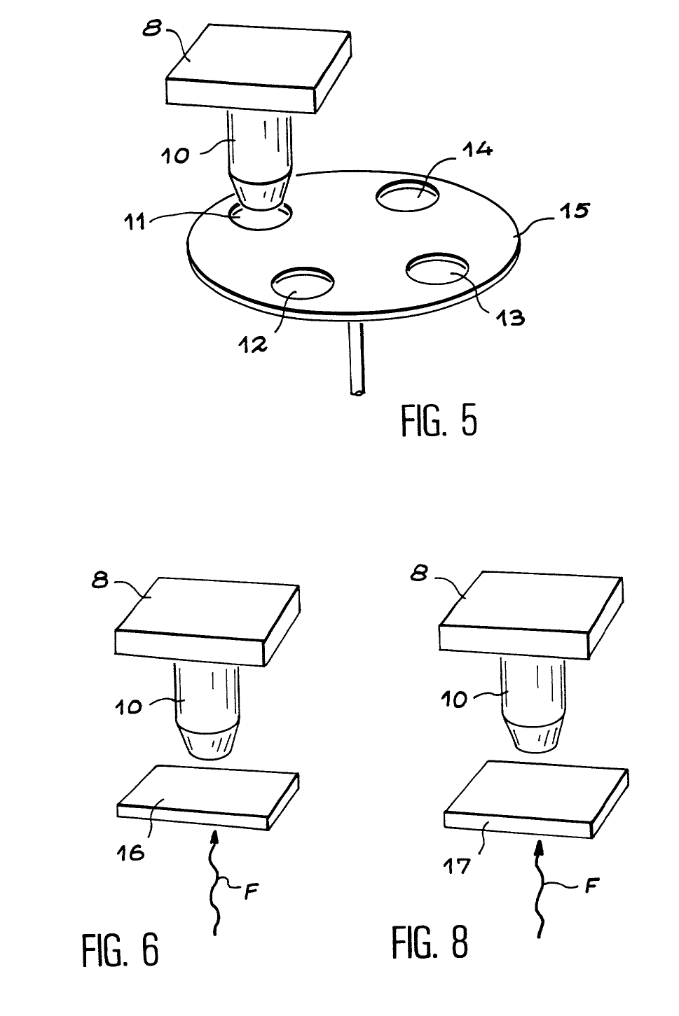

FIG. 5 illustrates a second example of the polarized fluorescent light readout device according to the invention.

According to this second example, two different tracers are imaged. For example, they may be R110 and TAMRA as mentioned earlier. The device comprises an objective lens 10, a CCD camera 8 and 4 polarizing filters 11, 12, 13 and 14 mounted on a filter wheel 15. Filters 11 and 12 filter the vertical polarization and the horizontal polarization of the fluorescent light from a first tracer, respectively and filters 13 and 14 filter the vertical polarization and the horizontal polarization of the fluorescent light from the second tracer, respectively. The respective intensities I_{//}R110, I_{⊥}R110, I_{//}TAMRA and I_{⊥}TAMRA are then successively measured by camera 8. For this purpose, the filter wheel 15 is switched with both excitation laser beams (not shown in the figure) synchronously, which successively illuminate the microchannels.

FIG. 6 illustrates a third example of the polarized fluorescent light readout device according to the invention.

In addition to objective lens 10 and to camera 8, the readout device comprises means for providing, for each tracer, simultaneous measurement of intensities I_{//} and I_{⊥}. The vertical and horizontal polarizations are then separated and projected on two distinct areas of the camera. Both polarizations contained in the fluorescent light F are separated by a birefringent crystal 16, for example a LiNbO₃ bar. A first image is then formed in a first color (first tracer) and a second image is formed in a second color (second tracer). The images are formed in succession, after switching the excitation laser beams. Of course, this is given as an example and the device may operate with a single color (in this case, only one tracer is used for detecting one type of nucleic acid) but also with three or even four colors (in this case, the matching number of tracers is used).

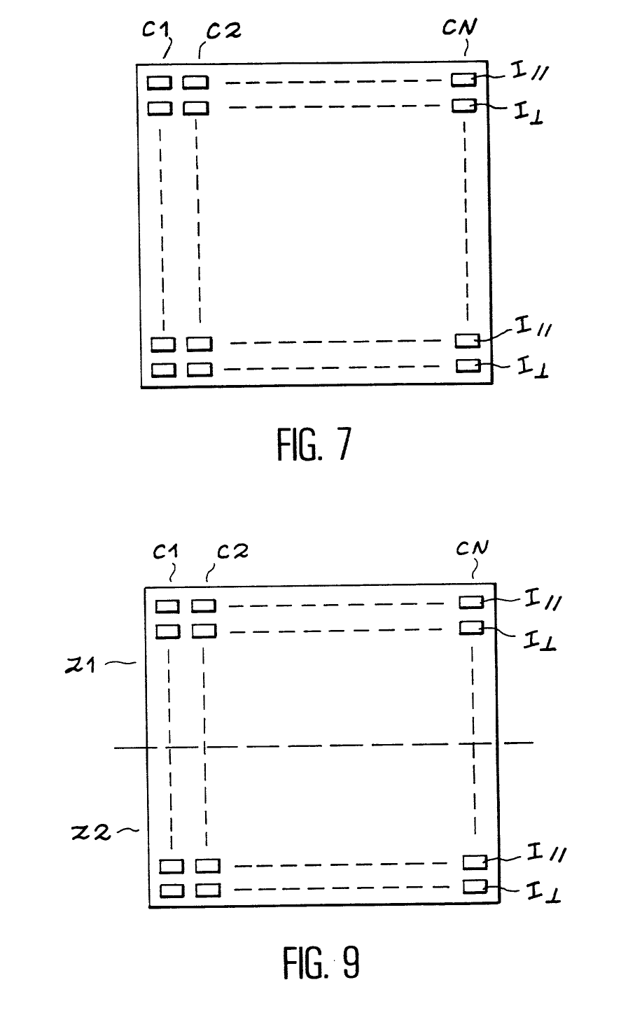

The fluorescence image obtained in one color is illustrated in FIG. 7. The fluorescence image Cj (j=1, 2, . . . , N) of a microchannel thus consists of a succession of pixel pairs, each pair of pixels illustrating a same microchannel area. The pixels of a same pair have as respective intensities, intensities I_{//} and I_{⊥}.

FIG. 8 illustrates a fourth example of the fluorescent light readout device according to the invention.

The readout device according to the fourth exemplary embodiment of the invention comprises means for forming a fluorescence image of the chip, simultaneously in both polarizations and in both colors.

On the formed image, both colors are separated into two distinct areas. Separation of the colors is achieved by shifting both laser beams which illuminate the microchannel structure. Moreover, a birefringent crystal, for example a calcite crystal 17 is interposed between the microchannel structure and the objective lens 10. The calcite crystal 17 enables the polarizations to be separated.

The image obtained by a device according to FIG. 8 is illustrated in FIG. 9.

The fluorescence image Cj (j=1, 2, . . . , N) of each microchannel is divided up into two areas: a Z1 area relative to a first color (first tracer) and a Z2 area relative to a second color (second tracer). Also as earlier, each image Cj consists of a succession of pixel pairs, each pair of pixels illustrating a same microchannel area, pixels of a same pair having as respective intensities, intensities I_{//} and I_{⊥}.

As a non-limiting example, the dimensioning of a fluorescence imaging device which was made for implementing the invention, is given below:

CCD array size: 1024×60 (24.6×1.44 mm²);

CCD array detection pixel size: 24×24 μm²;

microchannels: width 200 μm, pitch 400 μm, total overall dimensions along the microchannel axis 40 mm, fluorescence area along the microchannel axis 1 mm,

magnification 0.5;

image field on the camera # 30s;

number of pixels per microchannel: 4×20;

numerical aperture of the optics: 0.1 with a focal length of 10 mm, aperture f/2;

laser light power per microchannel: 100 μW.

1. A fluorescence image device comprising first means for containing constituents to be analyzed, second means for illuminating with polarized light the constituents to be analyzed and third means for reading out a fluorescence light emitted by the constituents under the action of the polarized light, characterized in that the first means consist of a parallel microchannel structure (4) and in that the second means comprise at least one coupling device (2, 5) for guiding polarized light into the microchannels.

2. The device according to claim 1, characterized in that the microchannels are etched in a glass or high optical quality plastic or silicon support chip.

3. The device according to claim 1, characterized in that the microchannels are flexible capillaries.

4. The device according to any of the preceding claims, characterized in that the coupling device comprises a diffraction grating (5).

5. The device according to any of claims 1 to 3, characterized in that the coupling device comprises a cylindrical lens (2).

6. The device according to claim 1, characterized in that the second means comprise a laser or a microlaser for illuminating the whole of the microchannel structure (4) and in that the third means comprise a first polarizing filter (6, 11, 13) for filtering, firstly, a first component of the polarized fluorescence light according to a first direction and a second polarizing filter (7, 12, 14) for filtering, secondly, a second component of the polarized fluorescence light according to a direction perpendicular to the first direction.

7. The device according to claim 6, characterized in that it comprises a filter wheel (9, 15) for switching the first filter (6, 11, 13) and the second filter (7, 12, 14).

8. The device according to any of claims 1, characterized in that the second means comprise a laser or microlaser for illuminating the whole of the microchannel structure (4) and in that the third means comprise a birefringent crystal (16, 17) for separating the fluorescence light emitted according to two components polarized perpendicularly to each other.

9. The device according to claim 6, characterized in that the laser or microlaser emits at a wavelength (λ1) substantially between 488 nm and 514 nm or at a wavelength (λ2) substantially between 550 nm and 580 nm.

10. The device according to claim 1, characterized in that the second means comprise a first laser or microlaser for illuminating a first area of the microchannel structure (4) and a second microlaser for simultaneously illuminating a second area of the microchannel structure (4) and in that the third means comprise a birefringent crystal (16, 17) for separating the fluorescence light emitted according to two components polarized perpendicularly to each other.

11. The device according to claim 10, characterized in that the first laser or microlaser emits at a wavelength (λ1) substantially between 488 nm and 514 nm and the second microlaser emits at a wavelength (λ2) substantially between 530 nm and 550 nm.

12. The device according to any of claims 8 or 10, characterized in that the birefringent crystal is a LiNbO₃ crystal or a calcite crystal.
